(19) United States
(12) Patent Application Publication
(10) Pub. No.: US 2026/0230928 A1
(43) Pub. Date: Aug. 6, 2026

(54) COMMUNICATION TERMINAL, DATA RECEPTION METHOD, AND PROGRAM RECORDING MEDIUM

(71) Applicant: NEC Corporation, Tokyo (JP)

(72) Inventor: Masahiko Kikuchi, Tokyo (JP)

(73) Assignee: NEC Corporation, Tokyo (JP)

(21) Appl. No.: 19/151,369

(22) PCT Filed: Feb. 7, 2023
(86) PCT No.: PCT/JP2023/004070

§ 371 Date: Jul. 28, 2025

(51) Int. Cl. H04W 28/08; H04W 28/02

(52) U.S. Cl. CPC H04W 28/0942; H04W 28/0226; H04W 28/0268

(57) ABSTRACT

A communication terminal installed with an application program that starts processing after receiving data from a wireless network and buffering a certain amount of the data, the communication terminal comprising: a memory configured to store instructions; and a processor configured to execute the instructions to: receive a prediction value of communication quality of the wireless network up to a predetermined time ahead; and increase or decrease a buffer amount to be received for the application program, based on the prediction value of the communication quality of the wireless network up to the predetermined time ahead.

This application is a National Stage Entry of PCT/JP2023/004070 filed on Feb. 7, 2023, the contents of all of which are incorporated herein by reference, in their entirety.

### TECHNICAL FIELD

The present invention relates to a communication terminal, a data reception method, and a program recording medium.

### BACKGROUND ART

Patent Literature 1 discloses an electronic device capable of preventing occurrence of a silent state as much as possible even when a communication situation deteriorates. According to Patent Literature 1, in response to receiving, from a user, an instruction to change stream data currently being played, when the communication situation is determined to be not good, the electronic device performs an operation of invalidating the instruction so as to continue the playback of the stream data currently being played. More specifically, the electronic device is mounted on a mobile object, and determines whether the communication situation is good, based on a position of the electronic device and communicable area information indicating an area where data communication is possible.

Patent Literature 2 discloses a data prediction apparatus that predicts a probability distribution of a future communication throughput based on the past time series data of the communication throughput.

### CITATION LIST

### Patent Literature

Patent Literature 1: JP 2012-100104 A
Patent Literature 2: WO 2014/141344 A1

### SUMMARY

### Technical Problem

In an application program that starts processing after receiving data from a wireless network and buffering a given amount of the data, it is known that, when the buffer is made too large, the start of processing such as playback of the received data is delayed, causing impairment of user experience (UX). On the other hand, when the buffer is small, the start of the processing such as the playback of the received data can be advanced, but as pointed out in Patent Literature 1, there is a problem that it is difficult to adapt to a change in communication quality.

In this regard, the electronic device disclosed in Patent Literature 1 determines whether the communication situation is good, based on the position of the electronic device and the communicable area information. Thus, there is a problem that it is not possible to cope with a change in the communication situation due to a factor other than the communicable area (e.g., refer to Patent Literature 2).

An object of the present disclosure is to provide a communication terminal, a data reception method, and a program recording medium with which, even when communication quality changes from moment to moment, it is possible to reduce deterioration of a quality of experience of a user of an application program that starts processing after buffering a given amount of data.

### Solution to Problem

According to a first aspect, there is provided a communication terminal installed with an application program that starts processing after receiving data from a wireless network and buffering a given amount of the data, the communication terminal including: a reception means for receiving a predicted value of communication quality of the wireless network up to a predetermined time ahead; and a first buffer adjustment means for increasing or reducing a buffer amount to be received for the application program, based on the predicted value of the communication quality of the wireless network up to the predetermined time ahead.

According to a second aspect, there is provided a data reception method in a communication terminal installed with an application program that starts processing after receiving data from a wireless network and buffering a given amount of the data, the data reception method including: receiving a predicted value of communication quality of the wireless network up to a predetermined time ahead; and increasing or reducing a buffer amount to be received for the application program, based on the predicted value of the communication quality of the wireless network up to the predetermined time ahead.

According to a third aspect, there is provided a program recording medium storing a program executable by a communication terminal installed with an application program that starts processing after receiving data from a wireless network and buffering a given amount of the data, the program causing the communication terminal to execute processing including: receiving a predicted value of communication quality of the wireless network up to a predetermined time ahead; and increasing or reducing a buffer amount to be received for the application program, based on the predicted value of the communication quality of the wireless network up to the predetermined time ahead.

### Advantageous Effects of Invention

According to the present disclosure, there are provided the communication terminal, the data reception method, and the program recording medium with which, even when the communication quality changes from moment to moment, it is possible to reduce the deterioration of the quality of experience of the user of the application program that starts the processing after buffering the given amount of data.

### BRIEF DESCRIPTION OF DRAWINGS

FIG. 1 illustrates a configuration according to an embodiment of the present disclosure.

FIG. 2 is a flowchart illustrating an operation according to an embodiment of the present disclosure.

FIG. 3 illustrates a configuration according to a first embodiment of the present disclosure.

FIG. 4 is a functional block diagram illustrating a configuration of a communication terminal according to the first embodiment of the present disclosure.

FIG. 5 is a sequence diagram illustrating an operation according to the first embodiment of the present disclosure.

FIG. 6 illustrates an operation of the communication terminal according to the first embodiment of the present disclosure.

FIG. 7 is a functional block diagram illustrating a configuration of a communication terminal according to a second embodiment of the present disclosure.

FIG. 8 illustrates an operation of the communication terminal according to the second embodiment of the present disclosure.

FIG. 9 is a functional block diagram illustrating a configuration of a communication terminal according to a third embodiment of the present disclosure.

FIG. 10 is a flowchart illustrating an operation of the communication terminal according to the third embodiment of the present disclosure.

FIG. 11 is a functional block diagram illustrating a configuration of a communication terminal according to a fourth embodiment of the present disclosure.

FIG. 12 is a flowchart illustrating an operation of the communication terminal according to the fourth embodiment of the present disclosure.

FIG. 13 illustrates an operation according to the fourth embodiment of the present disclosure.
FIG. 14 is a functional block diagram illustrating a configuration of a communication terminal according to a fifth embodiment of the present disclosure.
FIG. 15 illustrates a configuration of a computer constituting the communication terminal of the present disclosure.

### EXAMPLE EMBODIMENTS

First, an outline of an embodiment of the present disclosure will be described with reference to the drawings. Note that reference symbols added to this outline are added to individual elements for convenience, as an example for aiding understanding, and are not intended to limit the present disclosure to modes illustrated in the drawings. Additionally, connection lines between blocks in the drawings and the like referred to in the following description include both bidirectional and unidirectional. The one-way arrow schematically indicates the flow of a main signal (data) and does not exclude bidirectionality. A program is executed via a computer apparatus. The computer apparatus includes, for example, a processor, a storage device, an input device, a communication interface, and, as appropriate, a display device. Additionally, the computer apparatus is configured to be able to communicate with an inside device or an external apparatus (including a computer) via a communication interface irrespective of wired or wireless communication. Furthermore, although input and output connection points of each of the blocks in the drawings have ports or interfaces, their illustration is omitted.

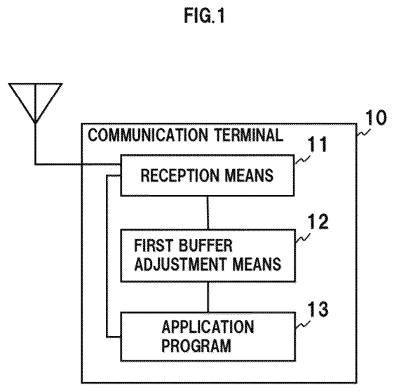

The present disclosure, in an embodiment thereof as illustrated in FIG. 1, may be implemented by a communication terminal 10 that includes a reception means 11 and a first buffer adjustment means 12 and is installed with an application program 13.

The application program 13 is an application program (hereinafter, also referred to as an “application”) of a type that starts processing after receiving data from a wireless network and buffering a given amount of the data. Examples of the application 13 include a video playback application, a music play back application, a navigation application, and an Internet content viewing application. Furthermore, the application 13 can also be regarded as a program for receiving and playing streaming data.

The reception means 11 receives a prediction value of communication quality of the wireless network up to a predetermined time ahead. As the prediction value of the communication quality of the wireless network, a prediction value calculated based on a change in a parameter related to the communication quality of the wireless network by an external server or the like can be used. The external server is not particularly limited as long as the prediction value of the communication quality of the wireless network up to the predetermined time ahead can be calculated, but for example, a data prediction apparatus of PTL 2 that predicts a probability distribution of time-series data from the time-series data can also be used.

The first buffer adjustment means increases or decreases a buffer amount received for the application program 13 based on the prediction value of the communication quality of the wireless network up to the predetermined time ahead.

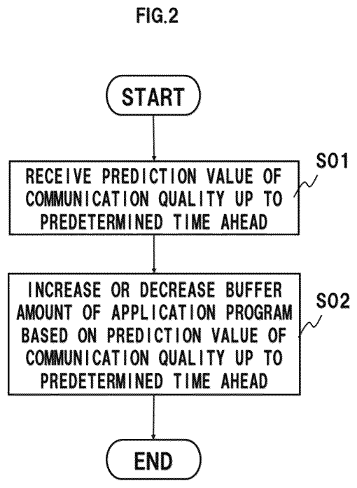

The communication terminal 10 configured as described above operates as follows. First, the communication terminal 10 receives a prediction value of communication quality of the wireless network up to a predetermined time ahead from an external server or the like (step S01 in FIG. 2).

Next, the communication terminal 10 increases or decreases a buffer amount of the app 13 based on the prediction value of the communication quality of the wireless network up to the predetermined time ahead (step S02 in FIG. 2). For example, in a case where it is found that the communication quality deteriorates after the predetermined time and the state continues for a predetermined time, the communication terminal 10 temporarily increases the buffer amount. As a result, since data accumulated in a buffer increases, reproduction of a moving image and the like in the app 13 is stabilized. Thereafter, in a case where it is found that the communication quality is recovered after a predetermined time and the state continues for a predetermined time, the communication terminal 10 returns the buffer amount to the original amount. As a result, although the data accumulated in the buffer decreases, there is no problem because the communication quality is recovered.

According to the communication terminal 10 that operates as described above, even in a case where the communication quality changes every moment, it is possible to suppress deterioration of user sensory quality (user experience (UX)) of the app 13.

### First Example Embodiment

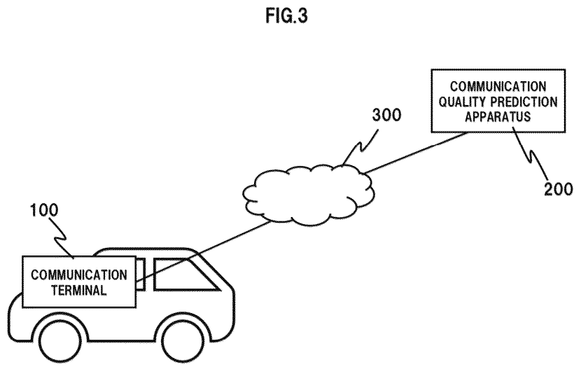

Subsequently, a first example embodiment in which the present disclosure is applied to a communication terminal 100 mounted on a vehicle will be described in detail with reference to the drawings. FIG. 3 is a diagram illustrating a configuration of the first example embodiment of the present disclosure. Referring to FIG. 3, the configuration including the communication terminal 100 that moves with the vehicle, a communication quality prediction apparatus 200, and a network 300 is illustrated.

The communication terminal 100 is assumed to be an in-vehicle terminal mounted on the vehicle, a mobile terminal of a passenger of the vehicle, or the like. In the following description, it is assumed that an app of a type that receives data from the network 300, buffers a certain amount of the data, and then starts processing is installed in the communication terminal 100, and a passenger of the vehicle is provided with a service using the app.

The communication quality prediction apparatus 200 predicts a future communication throughput at a predetermined time ahead based on time-series data of a past communication throughput of the communication terminal 100. A prediction value (prediction time-series data) of the future communication throughput relates to the “prediction value of the communication quality of the wireless network up to the predetermined time ahead” described above. The time-series data of the past communication throughput can be acquired from a management apparatus or the like on the network 300 that provides a communication service to the communication terminal 100. As a matter of course, the communication terminal 100, an edge server arranged on a side of the communication terminal, or the like may provide the time-series data of the past communication throughput to the communication quality prediction apparatus 200. As a method of predicting the communication throughput, for example, a method of predicting a probability distribution of the time-series data based on a prediction model created in advance can be used (see, for example, PTL 2). In the present example embodiment, the communication throughput is used as the time-series data to be predicted, but other parameters such as a received signal strength indicator (RSSI) may be used as the parameter related to the communication quality of the wireless network.

In the network 300, a server or the like that transmits data for an app to the communication terminal 100 is arranged.

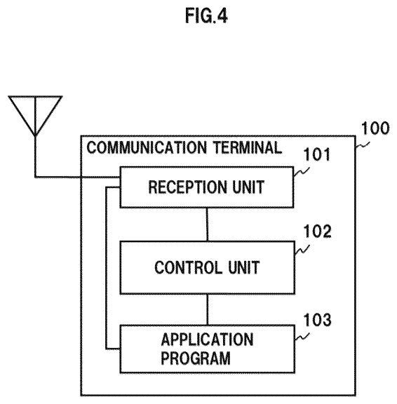

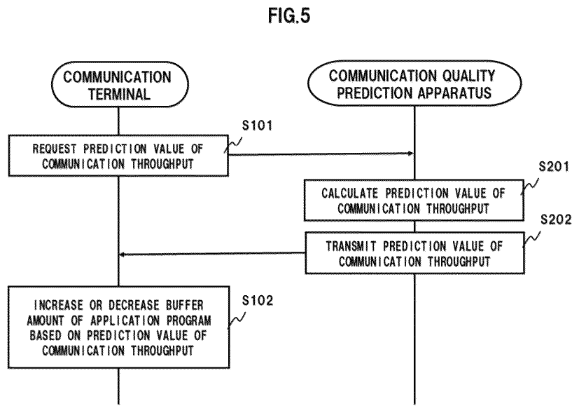

FIG. 4 is a functional block diagram illustrating a detailed configuration of the communication terminal 100. Referring to FIG. 4, the communication terminal 100 includes a reception unit 101 (related to the reception means described above) and a control unit 102. In the communication terminal 100, an application program 103 (hereinafter, the app 103) is installed in such a way as to be executable.

The reception unit 101 requests the communication quality prediction apparatus 200 described above to transmit time-series data (prediction time-series data) for which a communication throughput is predicted. When receiving the time-series data for which the communication throughput is predicted from the communication quality prediction apparatus 200 described above, the reception unit 101 transmits the time-series data to the control unit 102. Prediction accuracy of a prediction value of the communication quality prediction apparatus 200 may deteriorate as data is ahead in time (in the future). Therefore, it is desirable that the reception unit 101 requests the communication quality prediction apparatus 200 to transmit the time-series data at an interval at which the prediction accuracy of equal to or more than a certain level can be obtained.

The control unit 102 increases or decreases a buffer amount of the app 103 based on time-series data (prediction time-series data) for which a future communication throughput is predicted, which is received from the communication quality prediction apparatus 200. In the present example embodiment, in a case where the predicted time-series data indicates that deterioration of the communication quality occurs, the control unit 102 performs an operation of increasing the buffer amount of the app 103 before the occurrence. In the present example embodiment, the control unit 102 relates to the first buffer adjustment means described above.

Subsequently, an operation of the present example embodiment will be described in detail with reference to the drawings. FIG. 5 is a sequence diagram representing the operation of the first example embodiment. Referring to FIG. 5, first, the communication terminal 100 requests the communication quality prediction apparatus 200 to transmit time-series data representing a prediction value of a communication throughput at a predetermined time interval (step S101).

The communication quality prediction apparatus 200 that has received the transmission request of the time-series data representing the prediction value of the communication throughput calculates a prediction value of a future communication throughput based on time-series data of a past communication throughput (step S201). The communication quality prediction apparatus 200 then transmits, to the communication terminal 100, time-series data representing the prediction value of the communication throughput (step S202).

The communication terminal 100 that has received the time-series data representing the prediction value of the communication throughput increases or decreases a buffer amount of the app 103 based on the time-series data representing the prediction value of the communication throughput (step S102).

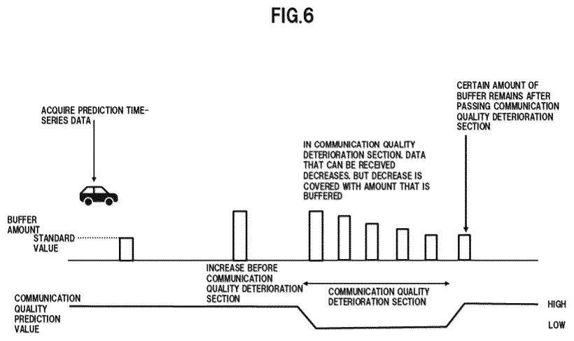

FIG. 6 is a diagram for describing an operation of the communication terminal of the first example embodiment. A horizontal axis of FIG. 6 indicates a position of the vehicle proceeding from a left side to a right side, a buffer amount of the app 103 is indicated in a middle part, and a transition of a communication quality prediction value is indicated in a lower part. In a case where prediction time-series data acquired by the vehicle indicates that there is a time when the communication quality deteriorates (communication quality deterioration section) as illustrated in the lower part of FIG. 6, the control unit 102 performs processing of increasing the buffer amount of the app 103 at a time point before the deterioration of the communication quality starts. As a result, as illustrated in FIG. 6, more data than a standard is accumulated before the communication quality deterioration section is entered. Since data that can be received decreases after the communication quality deterioration section is entered, the data accumulated in the buffer decreases, but since more data than the standard is accumulated, it is possible to reduce occurrence of a problem such as stopping processing of the app 103.

As described above, according to the present example embodiment, it is possible to secure a good UX even in a case where the communication quality changes every moment.

### Second Example Embodiment

In the first example embodiment described above, an example has been described in which the control unit 102 increases the buffer amount of the app 103 before the communication quality deteriorates, but a method of reducing the buffer amount of the app 103 can also be adopted in a case where it is known that the communication quality is improved.

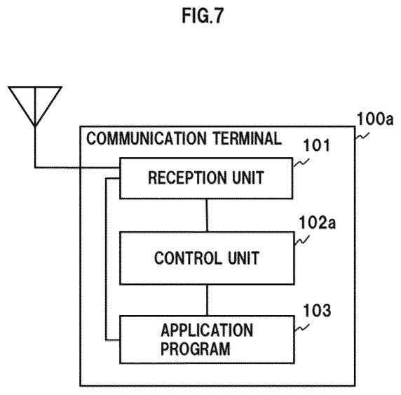

FIG. 7 is a functional block diagram illustrating a configuration of a communication terminal 100a of a second example embodiment. A difference from the communication terminal 100 of the first example embodiment illustrated in FIG. 4 is an operation of a control unit 102a. Since other configurations are similar to those of the first example embodiment, hereinafter, the difference will be mainly described.

In a case where prediction time-series data received from the communication quality prediction apparatus 200 indicates that the communication quality is improved, the control unit 102a performs an operation of reducing a buffer amount of an app 103 before occurrence of the improvement. In the present example embodiment, the control unit 102a relates to the first buffer adjustment means described above.

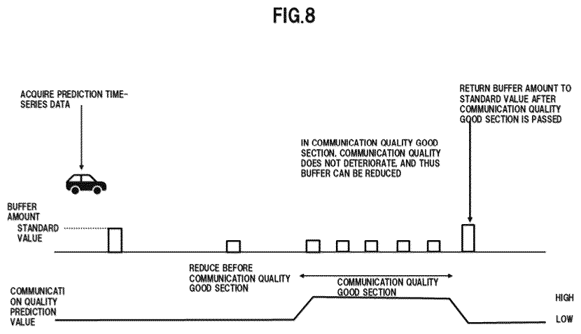

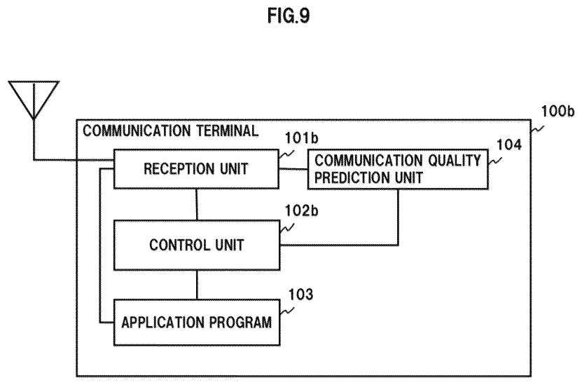

FIG. 8 is a diagram for describing an operation of the communication terminal of the second example embodiment. A horizontal axis of FIG. 8 indicates a position of a vehicle proceeding from a left side to a right side, a buffer amount of the app 103 is indicated in a middle part, and a transition of a communication quality prediction value is indicated in a lower part. In a case where prediction time-series data acquired by the vehicle indicates that there is a time when the communication quality is improved (communication quality good section) as illustrated in the lower part of FIG. 8, the control unit 102a performs processing of reducing the buffer amount of the app 103 at a time point before a change (improvement) of the communication quality starts. As a result, as illustrated in FIG. 8, the buffer amount decreases before the communication quality good section is entered. Since data can be received without any problem after the communication quality good section is entered, there is no problem even when data accumulated in the buffer is small.

As described above, also by the present example embodiment, it is possible to secure a good UX.

### Third Example Embodiment

In the first and second example embodiments described above, it has been described that the communication terminals 100 and 100a receive the prediction time-series data from the communication quality prediction apparatus 200, but it is also possible to arrange a communication quality prediction function on the side of the communication terminals.

FIG. 9 is a functional block diagram illustrating a configuration of a communication terminal 100b of a third example embodiment. Differences from the communication terminal 100 of the first example embodiment illustrated in FIG. 4 are that the communication terminal 100b includes a communication quality prediction unit 104, and accordingly, operations of a reception unit 101b and a control unit 102b are different. Since other configurations are similar to those of the first example embodiment, hereinafter, the differences will be mainly described.

The communication quality prediction unit 104 predicts a future communication throughput at a predetermined time ahead based on time-series data of a past communication throughput of the communication terminal 100b. The communication quality prediction unit 104 relates to first prediction means. In the present example embodiment, the communication throughput is used as the time-series data to be predicted, but other parameters such as a received signal strength indicator (RSSI) may be used as the parameter related to the communication quality of the wireless network.

The reception unit 101b requests, instead of the communication quality prediction apparatus 200, the communication quality prediction unit 104 to transmit time-series data for which a communication throughput is predicted. When receiving the time-series data for which the communication throughput is predicted from the communication quality prediction unit 104, the reception unit 101b transmits the time-series data to the control unit 102b.

The control unit 102b increases or decreases a buffer amount of an app 103 based on prediction time-series data predicted by the communication quality prediction unit 104.

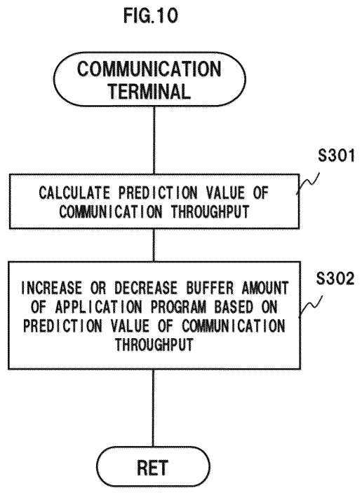

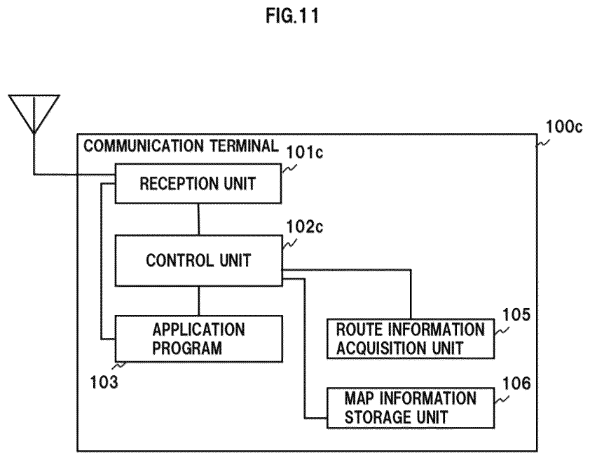

Subsequently, an operation of the present example embodiment will be described in detail with reference to the drawings. FIG. 10 is a flowchart representing an operation of the communication terminal of the third example embodiment. Referring to FIG. 10, first, the communication quality prediction unit 104 of the communication terminal 100 calculates time-series data representing a prediction value of a communication throughput at a predetermined time interval (step S301).

Next, the communication terminal 100 increases or decreases a buffer amount of the app 103 based on the time-series data representing the prediction value of the communication throughput (step S302).

According to the communication terminal 100b of the present example embodiment that operates as described above, it is possible to obtain a configuration in which the time-series data representing the prediction value of the communication throughput is calculated alone and the buffer amount is adjusted. Also in the present example embodiment, similarly to the second example embodiment, a mode can be adopted in which the buffer amount of the app 103 is reduced in a case where it is known that the communication quality is improved.

### Fourth Example Embodiment

Subsequently, a fourth example embodiment in which a communication terminal adjusts a buffer amount of an app 103 based on its own movement route, an obstacle on the route, base station information, and the like in addition to prediction time-series data will be described in detail with reference to the drawings.

FIG. 11 is a functional block diagram illustrating a configuration of a communication terminal 100c of the fourth example embodiment. Differences from the communication terminal 100 of the first example embodiment illustrated in FIG. 4 are that a route information acquisition unit 105 and a map information storage unit 106 are added to the communication terminal 100c, and accordingly, an operation of a control unit 102c is different. Since other configurations are similar to those of the first example embodiment, hereinafter, the differences will be mainly described.

The route information acquisition unit 105 acquires route information set in the communication terminal 100c. As the route information, route information acquired from a car navigation system, a route guidance service, or the like can be suitably used. That is, the route information may be a movement route to a destination set by a user of the communication terminal. The route information is not limited to these, and may be, for example, route information estimated from a current position and a movement direction of the communication terminal.

The map information storage unit 106 stores map information including buildings, obstacles, and the like on a map. The map information storage unit 106 may hold information related to a service area (rest area) of a mobile communication service as information accompanying the map.

The control unit 102c increases or decreases a buffer amount of the app 103 based on route information and map information in addition to increasing or decreasing the buffer amount of the app 103, based on time-series data for which a future communication throughput is predicted, which is received from the communication quality prediction apparatus 200. For example, in a case where it is found that there are an obstacle and a tunnel on a route of the communication terminal specified from the route information, the control unit 102c performs an operation of increasing the buffer amount of the app 103 before these sections in which significant deterioration of the communication quality is expected. Therefore, in the present example embodiment, the control unit 102c functions as second prediction means, the first buffer adjustment means, and second buffer adjustment means.

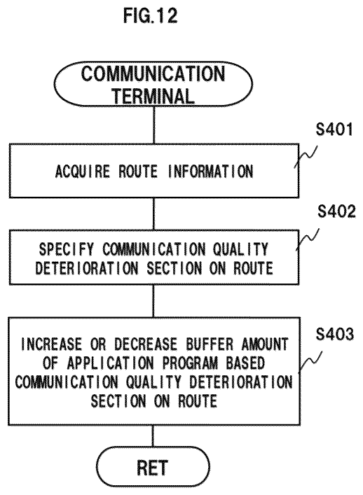

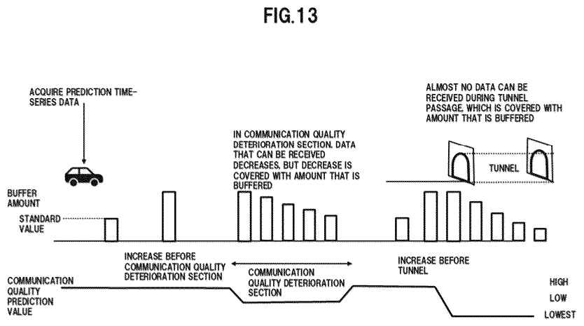

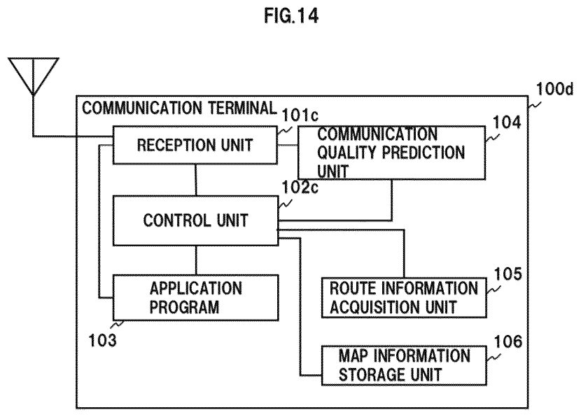

Subsequently, an operation of the present example embodiment will be described in detail with reference to the drawings. FIG. 12 is a flowchart representing an operation performed by the communication terminal of the fourth example embodiment independently of the processing of increasing or decreasing the buffer amount based on the time-series data for which the future communication throughput is predicted.

Referring to FIG. 12, first, the route information acquisition unit 105 of the communication terminal 100 acquires route information at a predetermined time interval (step S401). In a case where a user does not use a car navigation system or a route guidance service, the route information cannot be acquired, and thus subsequent processing may be omitted.

Next, with reference to the route information and map information, the control unit 102c of the communication terminal 100 specifies a section in which the communication quality on a route deteriorates (step S402). The control unit 102c of the communication terminal 100 increases or decreases a buffer amount of the app 103 based on the specified section (step S403).

FIG. 13 is a diagram for describing the operation of the communication terminal 100c of the fourth example embodiment. A horizontal axis of FIG. 13 indicates a position of a vehicle proceeding from a left side to a right side, a buffer amount of the app 103 is indicated in a middle part, and a transition of a communication quality prediction value is indicated in a lower part. An operation in the previous part of FIG. 13 is similar to that of the first example embodiment, and thus description thereof will be omitted. In the example of FIG. 13, the communication terminal 100c performs an operation to increase the buffer amount of the app 103 even before a tunnel. Since data that can be received significantly decreases after the tunnel is entered, data accumulated in the buffer greatly decreases, but since more data than a standard is accumulated, it is possible to reduce occurrence of a problem such as stopping processing of the app 103. In a more desirable mode, the control unit 102c of the communication terminal 100 desirably refers to route information and map information, and adjusts an amount of buffer increase with reference to a degree of deterioration in reception quality and a duration of the deterioration. For example, in a case where a section in which the data cannot be received such as the tunnel continues for a long time, a duration of a service by the app 103 can be lengthened by setting the buffer amount according to a length of the section, specifically, a length of the tunnel.

In a case where the map information includes information related to a service area (rest area) of the mobile communication service, the control unit 102c of the communication terminal 100 may increase or decrease the buffer amount based on the service area (rest area) information. For example, in a case where it is found according to a route specified from the route information that the route is out of the service area (rest area) for a certain period, the control unit 102c increases the buffer amount before the section. As a result, the period during which the service by the app 103 cannot be provided due to the service area (rest area) can be shortened.

As described above, according to the present example embodiment, it is possible to adjust the buffer amount of the app 103 by predicting the change in the communication quality due to the obstacle or the like on the actual route in addition to the prediction value predicted from the time-series data of the past communication quality. Particularly, it is possible to accurately predict the deterioration of the communication quality due to the entry into the tunnel, or the like, which is difficult to be predicted from the time-series data of the past communication quality, and to use it for changing the buffer amount.

### Fifth Example Embodiment

In the fourth example embodiment described above, it has been described that the communication terminal 100c receives the time-series data for which the future communication throughput is predicted from the communication quality prediction apparatus 200, but it is also possible to arrange the communication quality prediction unit 104 on the side of the communication terminal similarly to the third example embodiment.

FIG. 14 is a functional block diagram illustrating a configuration of a communication terminal of a fifth example embodiment of the present disclosure. A difference from the fourth example embodiment illustrated in FIG. 11 is that a communication terminal 100d includes a communication quality prediction unit 104. Other configurations and operations are similar to those of the third and fourth example embodiments, and thus description thereof will be omitted.

According to the present example embodiment, the effects of both the third example embodiment and the fourth example embodiment can be obtained.

Although each of the example embodiments of the present disclosure is described above, the present disclosure is not limited to the above-described example embodiments, and further modifications, substitutions, and adjustments can be made without departing from the basic technical idea of the present disclosure. For example, the network configuration, the configuration of each element, and the representation form of data that are illustrated in the drawings are merely examples that facilitate understanding of the present disclosure, and the present disclosure is not limited to those illustrated in the drawings.

### Hardware Configuration

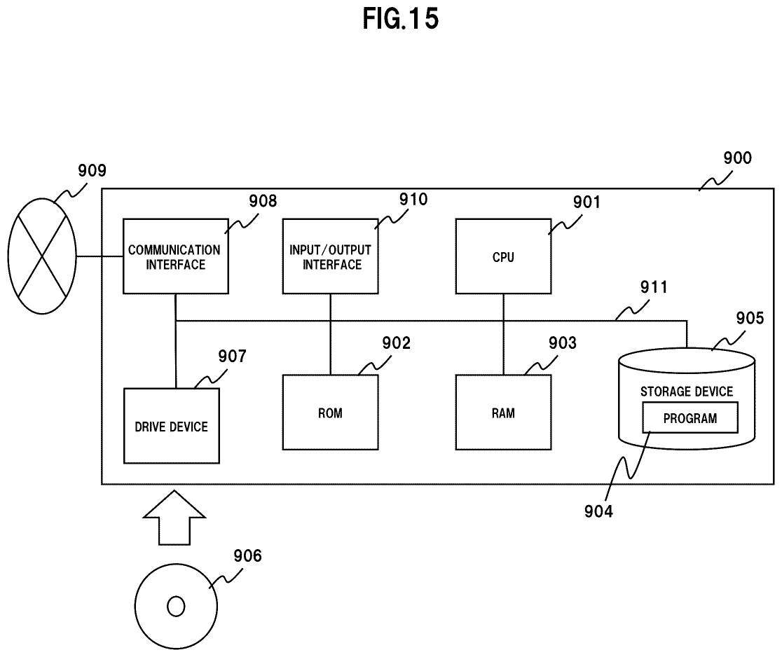

In each of the example embodiments of the present disclosure, each component of the apparatuses indicates a block of a functional unit. A part or all of the components the apparatuses is achieved by, for example, any combination of an information processing apparatus 900 and a program, as illustrated in FIG. 15. FIG. 15 is a block diagram illustrating an example of a hardware configuration of the information processing apparatus 900 that achieves each component of each apparatus. The information processing apparatus 900 includes the following configuration as an example.
Central processing unit (CPU) 901
Read only memory (ROM) 902
Random access memory (RAM) 903
Program 904 loaded onto RAM 903
Storage device 905 that stores program 904
Drive device 907 that reads from and writes into recording medium 906
Communication interface 908 connected with communication network 909
Input/output interface 910 for inputting/outputting data
Bus 911 connecting between components

The components of the apparatuses in the example embodiments are achieved by the CPU 901 acquiring and executing the program 904 for achieving the functions. That is, the CPU 901 in FIG. 15 may prediction time-series data acquiring program and a buffer amount changing program to perform update processing of calculation parameters stored the RAM 903, the storage device 905, or the like. The program 904 for achieving the functions of the components of the apparatuses is stored in the storage device 905 or the ROM 902 in advance, for example, and is read by the CPU 901 as necessary. The program 904 may be supplied to the CPU 901 via the communication network 909, or may be stored in advance in the recording medium 906 to be read by the drive device 907 and supplied to the CPU 901.

Various modifications exist for the method of achieving the apparatuses. For example, the apparatuses may be achieved by any combination of the information processing apparatus 900 and individual programs for each component. A plurality of components included in the apparatuses may be achieved by any combination of one information processing apparatus 900 and one program. That is, units (processing means and functions) of a communication terminal described in the first to third example embodiments may be achieved by a computer program that causes a processor mounted in the apparatus to execute the processing described above by using the hardware.

A part or all of the components of the apparatuses may be achieved by other general-purpose or dedicated circuits, processors, and the like, or a combination thereof. The circuits and the like may be configured by a single chip or may be configured by a plurality of chips connected to each other via a bus.

A part or all of the components of the apparatuses may be achieved by a combination of the above-described circuits and the like and a program.

When a part or all of the components of the apparatuses is achieved by a plurality of information processing apparatuses, circuits, and the like, the plurality of information processing apparatuses, circuits, and the like may be arranged to be centralized or to be distributed. For example, the information processing apparatus, the circuit, and the like may be achieved as a form such as a client and server system or a cloud computing system in which the apparatuses or the like are connected via a communication network.

The above-described example embodiments are preferred example embodiments of the present disclosure, and the scope of the present disclosure is not limited only to the above-described example embodiments. That is, it is possible for those skilled in the art to modify or substitute the above-described example embodiments and construct a mode in which various modifications are made without departing from the gist of the present disclosure.

For example, in the first to fifth example embodiments described above, the description has been made that the prediction time-series data calculated based on the time-series data of the past communication throughput is used, but a prediction value of the communication quality calculated using another method can also be used.

In the first to fifth example embodiments described above, it has been described that the control units 102 to 102c function as the second prediction means, the first buffer adjustment means, and the second buffer adjustment means, but the configuration that can be adopted by the communication terminals is not limited to this configuration. For example, a configuration in which the second prediction means, the first buffer adjustment means, and the second buffer adjustment means are provided independently of the control unit can also be adopted.

Some or all of the example embodiments described above may also be described as the following Supplementary Notes, but are not limited to the following Supplementary Notes.

### Supplementary Note 1

A communication terminal installed with an application program that starts processing after receiving data from a wireless network and buffering a certain amount of the data,
the communication terminal including:
reception means for receiving a prediction value of communication quality of the wireless network up to a predetermined time ahead; and
first buffer adjustment means for increasing or decreasing a buffer amount to be received for the application program, based on the prediction value of the communication quality of the wireless network up to the predetermined time ahead.

### Supplementary Note 2

The communication terminal described above can adopt a configuration in which,
as the prediction value of the communication quality of the wireless network, a prediction value calculated based on a change in a parameter related to the communication quality of the wireless network is used.

### Supplementary Note 3

The communication terminal described above can adopt a configuration provided with,
instead of the reception means,
first prediction means for calculating a prediction value obtained by predicting a change in the communication quality of the wireless network up to the predetermined time ahead based on a change in a parameter related to the communication quality of the wireless network,
in which the prediction value calculated by the first prediction means is used as the prediction value of the communication quality of the wireless network.

### Supplementary Note 4

The communication terminal described above can further adopt a configuration provided with:
second prediction means for predicting a change in the communication quality of the wireless network based on a position and a movement of the communication terminal and map information; and
second buffer adjustment means for increasing or decreasing the buffer amount to be received for the application program based on the change in the communication quality of the wireless network predicted by the prediction means.

### Supplementary Note 5

The second prediction means of the communication terminal described above can further adopt a configuration in which the change in the communication quality of the wireless network is predicted based on a movement route to a destination set by a user of the communication terminal.

### Supplementary Note 6

The application program of the communication terminal described above can adopt a configuration as a program for receiving and reproducing streaming data.

### Supplementary Note 7

A data reception method in a communication terminal installed with an application program that starts processing after receiving data from a wireless network and buffering a certain amount of the data,
the data reception method including:
receiving a prediction value of communication quality of the wireless network up to a predetermined time ahead; and
increasing or decreasing a buffer amount to be received for the application program, based on the prediction value of the communication quality of the wireless network up to the predetermined time ahead.

### Supplementary Note 8

A program recording medium recording a program for causing a communication terminal installed with an application program that starts processing after receiving data from a wireless network and buffering a certain amount of the data, to execute processing including:
receiving a prediction value of communication quality of the wireless network up to a predetermined time ahead; and
increasing or decreasing a buffer amount to be received for the application program, based on the prediction value of the communication quality of the wireless network up to the predetermined time ahead.

The modes described in the Supplementary Notes described above can be combined with each other after making necessary modifications. For example, a configuration having both the content described in Supplementary Note 2 and the content described in any one or more of Supplementary Notes 3 to 6 is also included in the disclosure scope of the present specification.

The modes of Supplementary Notes 7 and 8 described above can be expanded to the modes of Supplementary Notes 2 to 6, similarly to Supplementary Note 1.

The disclosures of each of the above PTLs is incorporated herein by reference, and may be used as the basis or a part of the present disclosure as necessary. Modifications and adjustments of the example embodiments or examples are possible within the scope of the overall disclosure (including the claims) of present disclosure and based on the basic technical concept of the present disclosure. Various combinations or selections (including partial deletions) of various disclosure elements (including the elements in each of the claims, example embodiments or examples, drawings, and the like) are possible within the scope of the present disclosure. That is, the present disclosure of course includes various variations and modifications that could be made by those skilled in the art in accordance with the technical concept. The description discloses numerical value ranges. However, even if the description does not particularly disclose any numerical values or sub-range included within the ranges, these values and ranges should be construed to have been concretely disclosed. Furthermore, the disclosures of the above-cited documents may be used, in part or in whole, in combination with the descriptions in this document, as part of this disclosure, in accordance with the gist of this disclosure, and such uses are deemed to be included in the disclosures of this application.

### REFERENCE SIGNS LIST

10, 100 to 100d communication terminal
11 reception means
12 first buffer adjustment means
13, 103 application program
101, 101b reception unit
102, 102a to 102c control unit
104 communication quality prediction unit
105 route information acquisition unit
106 map information storage unit
200 communication quality prediction apparatus
300 network
900 information processing apparatus
901 central processing unit (CPU)
902 read only memory (ROM)
903 random access memory (RAM)
904 program
905 storage device
906 recording medium
907 drive device
908 communication interface
909 communication network
910 input/output interface
911 bus

1. A communication terminal installed with an application program that starts processing after receiving data from a wireless network and buffering a certain amount of the data,
the communication terminal comprising:
a memory configured to store instructions; and
a processor configured to execute the instructions to:
receive a prediction value of communication quality of the wireless network up to a predetermined time ahead; and
increase or decrease a buffer amount to be received for the application program, based on the prediction value of the communication quality of the wireless network up to the predetermined time ahead.

2. The communication terminal according to claim 1, wherein, as the prediction value of the communication quality of the wireless network, a prediction value calculated based on a change in a parameter related to the communication quality of the wireless network is used.

3. The communication terminal according to claim 1, wherein the processor further configured to execute the instructions to:
instead of the receiving e a prediction value of communication quality of the wireless network up to a predetermined time ahead,
calculate a prediction value obtained by predicting a change in the communication quality of the wireless network up to the predetermined time ahead based on a change in a parameter related to the communication quality of the wireless network,
wherein the prediction value calculated by the processor is used as the prediction value of the communication quality of the wireless network.

4. The communication terminal according to claim 1, wherein the processor further configured to execute the instructions to:
predict a change in the communication quality of the wireless network based on a position and a movement of the communication terminal and map information; and
second increase or decrease the buffer amount to be received for the application program based on the change in the communication quality of the wireless network predicted by the prediction.

5. The communication terminal according to claim 4, wherein the processor further configured to execute the instructions to:
predict the change in the communication quality of the wireless network based on a movement route to a destination set by a user of the communication terminal.

6. The communication terminal according to claim 1, wherein the application program is a program for receiving and reproducing streaming data.

7. A data reception method in a communication terminal installed with an application program that starts processing after receiving data from a wireless network and buffering a certain amount of the data,
the data reception method comprising:
receiving a prediction value of communication quality of the wireless network up to a predetermined time ahead; and
increasing or decreasing a buffer amount to be received for the application program, based on the prediction value of the communication quality of the wireless network up to the predetermined time ahead.

8. A non-transitory computer-readable storage medium storing a program recording medium recording a program for causing a communication terminal installed with an application program that starts processing after receiving data from a wireless network and buffering a certain amount of the data, to execute processing comprising:
receiving a prediction value of communication quality of the wireless network up to a predetermined time ahead; and
increasing or decreasing a buffer amount to be received for the application program, based on the prediction value of the communication quality of the wireless network up to the predetermined time ahead.
